(19) United States
(12) Patent Application Publication
(10) Pub. No.: US 2006/0182306 A1
(43) Pub. Date: Aug. 17, 2006

(54) COMPONENT OF A TRACTION DEVICE, METHOD OF MANUFACTURING AND TRACTION DEVICE USING THE SAME

(75) Inventors: Christian HUNT, McLean, VA (US); Ara BOGHOSIAN, Alexandria, VA (US); John A. SPADAVECCHIA, Red House, VA (US)

Correspondence Address: GREENBLUM & BERNSTEIN, P.L.C., 1950 ROLAND CLARKE PLACE, RESTON, VA, 20191, US

(73) Assignee: CARE REHAB & ORTHOPEDIC PRODUCTS, INC., McLean, VA (US)

(21) Appl. No.: 11/275,972

(22) Filed: Feb. 7, 2006

Related U.S. Application Data
(60) Provisional application No. 60/653,106, filed on Feb. 16, 2005.

(51) Int. Cl. H04R 9/06; H04R 11/02

(52) U.S. Cl. 381/423; 381/396

(57) ABSTRACT

A process of conditioning a corrugated diaphragm adapted for use in a traction device in order to impart a spring force. The process includes obtaining a neutral state corrugated diaphragm with a length of predetermined size. The process further includes heating the corrugated diaphragm at a predetermined temperature and time to reduce the overall length of the corrugated diaphragm and increase a minor and major diameter of the corrugated diaphragm. The process further includes having the corrugated diaphragm installed on the traction device at a length greater than the reduced overall length and less than the neutral state.

### CROSS REFERENCE TO RELATED APPLICATIONS

This application claims priority to U.S. Provisional Application Ser. No. 60/653,7106, filed on Feb. 16, 2005, the contents of which are incorporated in its entirety herein.

### FIELD OF THE INVENTION

The invention generally relates to a component of a cervical and/or lumbar traction device and method of manufacturing, and more particularly, to a diaphragm device for use in a cervical and/or lumbar traction device and a method of manufacturing the diaphragm device.

### DISCUSSION OF BACKGROUND INFORMATION

Traction devices are used to relieve pressure on inflamed or enlarged nerves. Cervical and lumbar or spinal traction devices are the most common type of these devices. When correctly used, the traction devices can relieve pain in the neck and the spine by, for example, straightening the curvature of the spine or stretching of the spinal and cervical musculature.

Portable traction devices are now becoming very popular for in home use. These devices allow patients to perform traction therapy without leaving their homes, or expending large sums of money for a healthcare provider or physical therapist. Under the proper guidance and instruction, these portable devices are becoming ever more common, especially in today's age of rising health care costs.

### SUMMARY OF THE INVENTION

In a first aspect of the invention, a process of conditioning a corrugated diaphragm adapted for use in a traction device in order to impart a spring force. The process includes obtaining a neutral state corrugated diaphragm with a length of predetermined size. The process further includes compressing the corrugated diaphragm and heating the corrugated diaphragm at a predetermined temperature and time to reduce the overall length of the corrugated diaphragm and increase a minor and major diameter of the corrugated diaphragm. The process further includes having the corrugated diaphragm installed on the traction device at a length greater than the reduced overall length and less than the neutral state.

In another aspect of the invention, a corrugated diaphragm comprises a first length, in an unattached state, and a second length when attached to the traction device. The second length is greater than the first length. The diaphragm further has a spring force which, when attached to the traction device, retracts the carriage, upon release of pressure, towards its original position.

In yet another aspect of the invention, the traction device has a corrugated diaphragm device for providing a traction and spring force. The traction device includes a stationary frame and a traction device slidably mounted on the stationary frame. The corrugated diaphragm is mounted to a portion of the stationary frame and a portion of the traction device. The corrugated diaphragm includes a first length, in an unattached state, and a second length when attached to the traction device. The second length is greater than the first overall length. The corrugated diaphragm has a spring force that upon release of pressure is structured to retract the traction device towards its original position.

### BRIEF DESCRIPTION OF THE DRAWINGS

The present invention is further described in the detailed description which follows, wherein:

FIG. 1 shows a cut-away view of the cervical traction device in accordance of the invention;

FIG. 2 shows an exploded view of the cervical traction device in accordance of the invention;

FIG. 3 shows a lumbar traction device in accordance of the invention; and

FIG. 4 shows an exploded view of the lumbar traction device in accordance of the invention.

### DETAILED DESCRIPTION OF EMBODIMENTS OF THE INVENTION

The invention is directed to a component and method of manufacture a component used in a cervical and/or a lumbar traction device. More particularly, the invention is directed to a corrugated diaphragm used in a traction device and a method of manufacture. The corrugated diaphragm includes a certain spring force which is capable, upon the release of pressure therein, to move a carriage of the traction device towards its original position and, in embodiments, substantially to its original position. The spring force can overcome forces acting on the carriage such as, for example, the weight of the carriage and friction acting on the carriage. In addition to its own spring force, a roll spring or other spring or resilient type mechanism may be used in combination with the diaphragm, to retract the carriage towards its original position. The diaphragm is also devoid of moving parts. The corrugated diaphragm is configured to minimize leakage. The cervical and/or a lumbar traction device, using the diaphragm and related components, is lighter and includes less parts than devices using pneumatic cylinders.

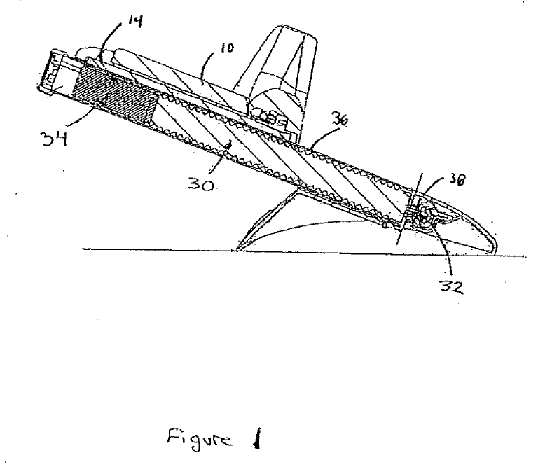

FIG. 1 shows an embodiment of the cervical traction device. The traction device 2 includes a stationary housing (e.g., frame) 4 having a moveable stand 6 which is structured and adapted so that several angles can be achieved relative to a flat surface, e.g., a floor or other surface where a user may use the device 2. The cervical traction device 2 further includes a movable headrest 10 having an occiput wedge system 12, which is mounted to a sliding carriage 14. A strap or other restraining device 16 for restraining a user's head is attached to the movable head-rest system 10.

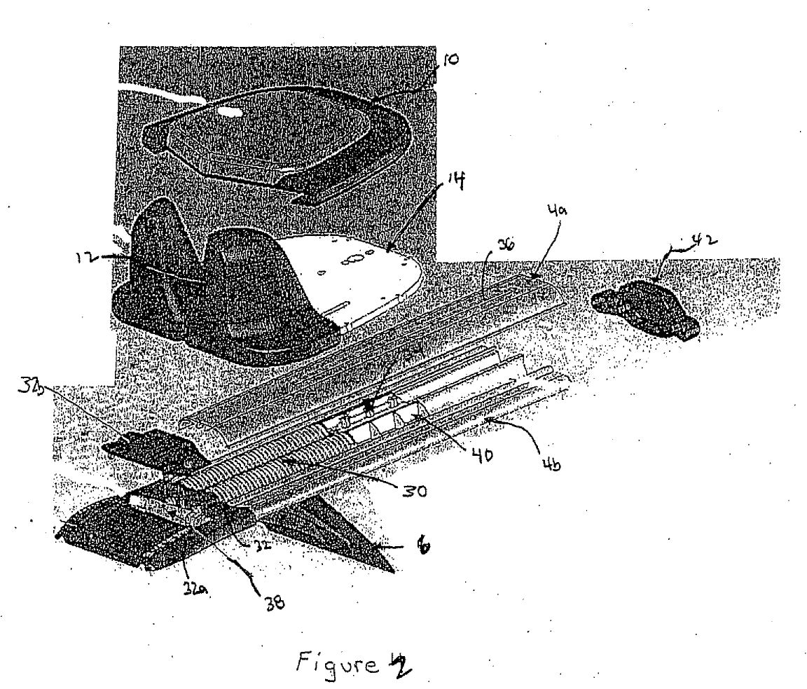

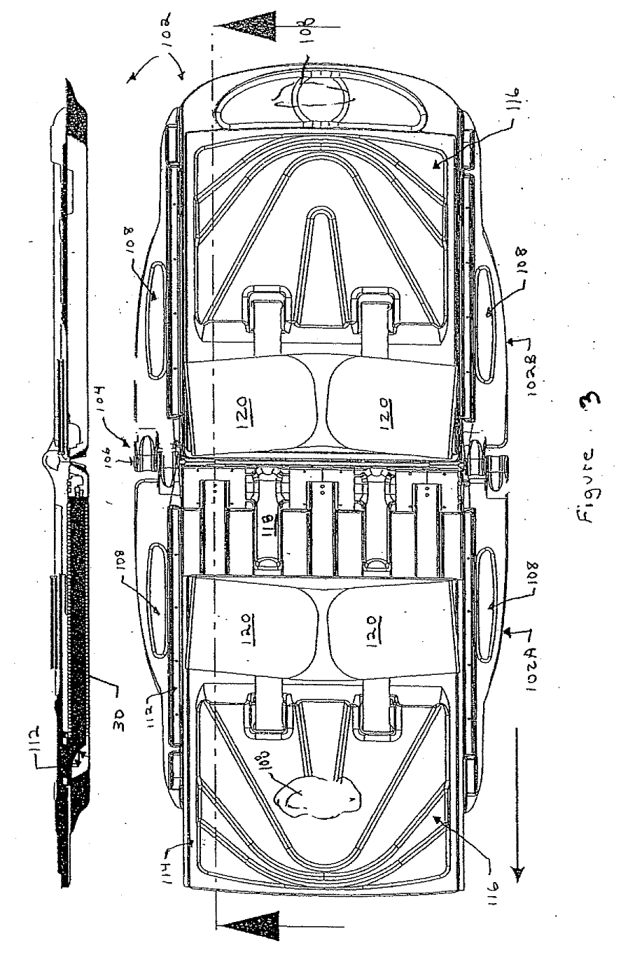

The occiput wedge system 12 includes separate wedges 12a that may have a concave engaging surface. The occiput wedge system 12, with the headrest 10, may be slidably movable along a longitudinal axis “Y” of the housing 4 by a corrugated diaphragm type device (shown more clearly in FIG. 3). The occiput wedge system 12 is designed to apply a therapeutic traction force to the occipital areas on a patent's head, while the housing 4 remains stationary. This is accomplished, in one aspect of the invention, by pressure being applied by a pump P via a hose H, to the diaphragm type device (See FIG. 2.). Thus, upon pressurization, the corrugated diaphragm type device will move or slide the carriage 14 and thus the headrest 10 and occiput wedge system 12. The pump “P” may have a manual pressure relief mechanism 18, as well as a gauge 20 to show the units of force being applied by the diaphragm type device. The occipital wedges do not rotate; instead they are specifically designed to move only linearly.

FIG. 2 shows a cutaway view of the traction device in accordance with the invention. The traction device 2 includes a corrugated diaphragm type device 30 that is mounted within or mounted to the housing 4. In embodiments, the corrugated diaphragm type device 30 is mounted between a support structure 32 of the housing 4 and the movable carriage 14. In one implementation, at least one boss 34 extends between the sliding carriage and the moveable carriage 14, via a slot 36 extending substantially along a length of the housing 4. In this embodiment, the corrugated diaphragm type device 30 is attached to the boss 34 and, upon pressurization of the corrugated diaphragm type device 30, will move the carriage 14 to apply a traction force.

The corrugated diaphragm type device 30 is connected to an air inlet or manifold 38 provided at an end of the housing 4, proximate to the support structure 32. The manifold 38 is connected to one or more of the diaphragm type devices 30 and is structured to allow pressurized air from the pump “P” to pass into the corrugated diaphragm type device 30.

Still referring to FIG. 2, the corrugated diaphragm type device 30 acts as a spring, e.g., has its own spring force, to retract the carriage in both a cervical and lumbar traction system from an expanded position. In one exemplary illustration, the corrugated diaphragm type device 30 can be expanded to approximately 10.5 inches in the expanded position, and in one embodiment may have a starting position of about 6.5 inches in length (with a neutral length of approximately 8 inches). It is also contemplated that other starting and expanded positions are provided by the invention. In one implementation, a stroke length of the corrugated diaphragm type device 30 is approximately 4 inches; although other stroke lengths are also contemplated by the invention.

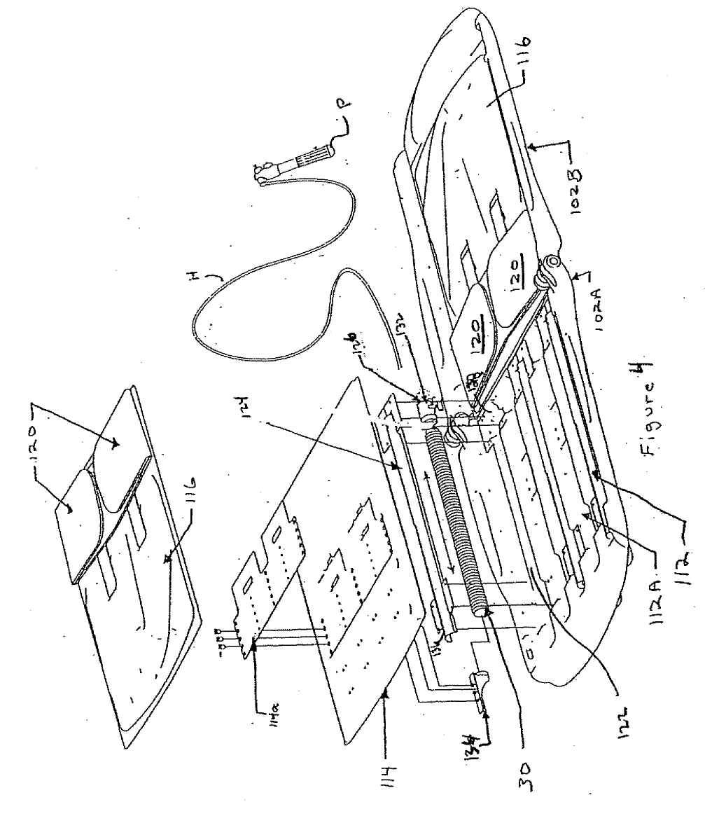

FIGS. 3 and 4 show an embodiment of the lumbar traction device 100 using the corrugated diaphragm type device 30. Similar to the traction device shown and described with reference to FIGS. 1 and 2, a corrugated diaphragm type device 30 is used to apply a traction type force. In the lumbar traction device 100, three corrugated diaphragm type devices may be used to provide the required traction force.

Integrally molded frame members 102A and 102B are hingedly attached via a hinge type mechanism 104 (which may be an alternating type hinge mechanism having at least four parts) to form a portable, foldable device. In the closed position, for example, the frame members 102A and 102B face one another; whereas, in the open state, the frame members 102A and 102B extend along a longitudinal axis in a single plane. Thus, the design of the traction device allows for the easy closing and opening of the lumbar traction device 100 without the requirement for aligning any parts, lifting any of the parts or separating any of the parts. The lumbar traction device 100 also includes integrally formed handles 108, for example, molded on sides or the ends thereof.

The frame members 102A and 102B are designed to house or mount thereon many of the components of the lumbar traction device 100, such as the corrugated diaphragm type device 30. By way of illustration, the lumbar traction device 100 may include guides 112 positioned on opposing sides of the frame member 102A and/or frame member 102B. The guides 112 are designed to seat thereon a slidable lumbar carriage 114 (typically on one frame). The lumbar carriage 114 is slidably moveable along the longitudinal axis of the frame to provide a traction force such that upon pressurization or release thereof, the corrugated diaphragm type device moves the slidable lumbar carriage 114 in directions “A” and “B”. In one embodiment, the lumbar carriage 114 includes a support pad 116 for the comfort of a user. A pair of belts or other restraining device 120 can be mounted to the support pad 116 and/or the frame member(s). The slidable lumbar carriage 114 may also be seated within a recessed portion 118 of the frame.

The corrugated diaphragm type device 30 acts as a spring, e.g., has its own spring force, to retract the carriage in both a cervical and lumbar traction system from an expanded position. In one exemplary illustration, the corrugated diaphragm type device 30 can be expanded to approximately 10.5 inches in the expanded position, and in one embodiment may have a starting position of about 6.5 inches in length. It is also contemplated that other starting and expanded positions are provided by the invention. In one implementation, a stroke length of the corrugated diaphragm type device 30 is approximately 4 inches; although other stroke lengths are also contemplated by the invention.

The following are illustrative examples of the process of manufacturing the corrugated diaphragm type device 30. It should be understood, though, that other examples and embodiments are equally applicable and fall within the scope of the inventive concept herein. By way of one illustration, the material of the corrugated diaphragm type device 30 is DuPont® Hytrel™ (44 durometer). In other examples, the material may be Thermoplastic Elastomer or other material having similar characteristics.

TABLE 1

| MATERIAL CHARACTERISTICS | METHOD | UNITS | VALUE |
|---|---|---|---|
| Density | ISO 1183 | g.cm | 1.27 |
| Tensile Strength @ Yield | ISO 527 | Mpa | 53 |
| Tensile Strength @ Break | ISO 527 | Mpa | 26 |
| Elongation @ Break | ISO 527 | % | >200 |
| Tensile Modulus of Elasticity | ISO 527 | Mpa | 2200 |
| Flexural Strength | ISO 178 | Mpa | 79 |
| Charpy Notched Impact Strength | ISO 179 | Kj.m2 | 10 |
| Charp Unnotched | ISO 179 | Kj.m2 | No Break |
| Rockwell Hardness M/R scale | | | (*)/115 |
| Ball Indentation | ISO 2039 | Mpa | (*) |

Of course other known polymers having durable, flexible and resilient type material properties capable of providing a spring force upon conditioning are also contemplated by the invention.

The diaphragm can be manufactured as part of the process, or purchased from any known supplier of diaphragm type devices Initially, the diaphragm is approximately eight inches in length with a major diameter of 1.250 inches and a minor diameter of 0.975 inches; although other parameters are equally applicable to the present invention.

The diaphragm is compressed within a fixture (not shown) and conditioned at approximately 250°-260° F. for approximately 75 minutes. In one embodiment, the compression is about 65% of its original length, e.g., maintains about 35% Of its original length during compression. Due to this conditioning, the length of the corrugated diaphragm type device 30 is reduced by approximately 3.75 inches, to approximately 4.25 inches. Of course, the overall length can be reduced by other lengths, depending on compression length, the time and temperature of the conditioning, as well as the material used and the original major and minor diameters. Upon conditioning, in the example provided herein, the major diameter of the conditioned part is approximately 1.270 inches, compared to 1.250 inches for the major diameter of the non-conditioned part. The minor diameter of conditioned part is approximately 0.98 inches, compared to 0.975 inches for the minor diameter of the non-conditioned part

When installed, the corrugated diaphragm type device 30 is stretched to maintain a state, in a non-pressurized state, of approximately six inches. In the case of other initial lengths and conditioning parameters, size of the traction device, etc. the corrugated diaphragm type device 30 can be stretched to other lengths in a non-pressurized state. In the example provided herein, the shrinkage in combination with the initial expanded state of the corrugated diaphragm type device 30, at installation, results in a spring force of 1-2.5 lbs. over a four inch extension.

The corrugated diaphragm type device 30 can be installed by an OEM. Alternatively, the manufacturer can have a third party vendor or alternatively other parties can install the corrugated diaphragm type device 30, but this is not preferable. A manufacturer of the traction device can provide authorization or instructions to a third party to install the corrugated diaphragm.

While the invention has been described in terms of embodiments, those skilled in the art will recognize that the invention can be practiced with modification.

What is claimed:

1. A process of conditioning a corrugated diaphragm adapted for use in a traction device in order to impart a spring force, comprising:
obtaining a neutral state corrugated diaphragm with a length of predetermined size;
compressing and heating the corrugated diaphragm at a predetermined temperature and time to reduce the overall length of the corrugated diaphragm and increase a minor and major diameter of the corrugated diaphragm; and
having installed the corrugated diaphragm on the traction device at a length greater than the reduced overall length and less than the neutral state.

2. The process of claim 1, wherein a manufacturer of the traction device installs the corrugated diaphragm.

3. The process of claim 1, wherein a manufacturer of the traction device has a third party install the corrugated diaphragm.

4. The process of claim 1 wherein a manufacturer of the traction device provides instructions for a third party to install the corrugated diaphragm.

5. The process of claim 1, wherein the heating imparts a spring force to the corrugated diaphragm.

6. The process of claim 1, wherein the heating is performed at approximately 250°-260° F. for approximately 75 minutes.

7. The process of claim 1, wherein the heating reduces the overall length to approximately 4.25 inches.

8. The process of claim 1, wherein the corrugated diaphragm is stretched to approximately six inches when installed on the traction device.

9. The process of claim 1, wherein the reduced size and the expanding of the length during installation results in a spring force of 1-2.5 lbs over a four inch extension.

10. The process of claim 1, wherein the heating causes the major diameter to increase to approximately 1.270 inches and the minor diameter to increase to approximately 0.98 inches.

11. The process of claim 1, wherein the corrugated diaphragm has a spring force such that the corrugated diaphragm retracts the carriage, upon release of pressure, towards its original position.

12. A corrugated diaphragm adapted for use in a traction device in order to impart a spring force, wherein the corrugated diaphragm comprises a first length, in an unattached state, and a second length when attached to the traction device, the second length being greater than the first length, the corrugated diaphragm further having a spring force when attached to the traction device which is greater than forces acting on a carriage of the traction device such that the corrugated diaphragm overcomes such forces and retracts the carriage, upon release of pressure, towards its original position.

13. The corrugated diaphragm of claim 12, wherein the first overall length is approximately 4.25 inches and the second overall length is stretched to approximately six inches when installed on the traction device.

14. The corrugated diaphragm of claim 12, wherein the reduced size and the expanding of the length results in a spring force of 1-2.5 lbs. over a four inch extension.

15. The corrugated diaphragm of claim 12, wherein a major diameter is approximately 1.270 inches and a minor diameter is approximately 0.98 inches.

16. A traction device having a corrugated diaphragm device for providing a traction and spring force, comprising:
a stationary frame;
a traction device slidably mounted on the stationary frame, and
the corrugated diaphragm being mounted to a portion of the stationary frame and a portion of the traction device, the corrugated diaphragm comprising:
a first length, in an unattached state, and a second length when attached to the traction device, the second overall length being greater than the first overall length; and
a spring force structured to overcome forces acting on a carriage of the traction device when pressure is released such that the spring force is capable of retracting the carriage towards its original position.
